(19) United States
(12) Patent Application Publication
(10) Pub. No.: US 2002/0114987 A1
(43) Pub. Date: Aug. 22, 2002

(54) Method of arraying nanoparticles and macromolecules on surfaces

(76) Inventors: Sven Oscarsson, Uppsala (SE); Anna Bergman, Uppsala (SE); Arjan Quist, Goleta, CA (US); Joe Buijs, Uppsala (SE); Bo Sundqvist, Uppsala (SE); Curt Reimann, Uppsala (SE)

Correspondence Address: BIRCH STEWART KOLASCH & BIRCH, PO BOX 747, FALLS CHURCH, VA, 22040-0747, US

(21) Appl. No.: 10/096,133

(22) Filed: Mar. 11, 2002

Related U.S. Application Data
(63) Continuation of application No. 09/509,185, filed on Jul. 5, 2000, now abandoned.
Application No. 09/509,185 is a 371 of international application No. PCT/SE98/01712092, filed on Sep. 23, 1998.

(30) Foreign Application Priority Data
Sep. 24, 1997 (SE) 9703447-4

(51) Int. Cl. H01M 8/10

(52) U.S. Cl. 429/33

(57) ABSTRACT

A method of arraying nanoparticles and macromolecules on surfaces, wherein a pattern of surface defects are created on a surface, the form, appearance and mapping out of the surface defects being adapted to those nanoparticles and/or macromolecules which are to be arrayed.

### BACKGROUND OF THE INVENTION

1. Technical Field

The invention relates to a method of arraying nanoparticles and macromolecules on surfaces in order to obtain an arrayed immobilisation of said particles in a desired pattern.

2. Technical Background

The more or less random adsorption to surfaces of macromolecules and colloidal particles (nanoparticles) has been studied for more than 100 years with different methods, e.g. A. E. G. Cass (Eds.) Biosensors: A Practical Approach (Oxford University Press, 1990); M. J. Wirth, R. W. Peter Fairbank and H. O Fatunmby, Science 275 (1997) 44; A. S. Hoffman, Am. N.Y. Acad. Sci. 516 (1987) 96; J. S. Miller, Adv. Mater. 2 (1990) 378; G. Schick, A. Lawrence and R. Birge, Trends in Biotech. 6 (1988) 159; L. A. Bottomley, J. E. Coury and P. N. First, Anal. Chem. 68 (1996) 185; P. K. Hansma et al, Appl. Phys. Lett. 64 (1994) 1738; A. p. Quist, L. P. Björck, C. T. Reimann, S. O. Oscarsson and B. U. R. Sundqvist, Surf. Sci. 325 (1995) L406; D. A. Erie, G. Yang, H. C. Schultz and C. Bustamante, Science 266 (1994)1562. However, obtaining an arrayed immobilization of these particles is of outmost importance in order to be able to build molecular or particulate memories, macromolecule or particle based surfaces for information-transfer, sofisticated analytical measuring methods and separation methods for analysis and separation of single molecules and particles. Other areas of application are artificial membranes, biocatalytical surfaces and biomaterials.

### SUMMARY OF THE INVENTION

The object of the present invention is to provide a method of arraying nanoparticles and macromolecules on surfaces.

This and other objects of the invention is achieved with the method according to the present invention, wherein a pattern of surface defects are created on a surface, the form, appearance and mapping out of the surface defects being adapted to those nanoparticles and/or macromolecules which are to be arrayed.

According to a preferred embodiment of the invention, holes and/or rises having a diameter and a depth and a height, respectively, within the interval of 1-50 nanometers, and a mutual distance within the interval of 0.1-1000 nanometers are created.

According to one embodiment of the invention surface defects in the form of lines are created in the surface.

According to a further development of the invention a surface is used, comprising organic or inorganic material.

According to a further development of the invention, the surface is coated with polymers of inorganic or organic material before the creation of surface defects, and subsequently selective surface modifications are made in order to provide the area containing the surface defects with desired chemical or mechanical characteristics.

According to a further embodiment of the invention, the thickness of the coating is varied throughout the surface whereby holes with different depths and/or diameters can be created.

According to a further embodiment of the invention, the surface defects are created by using finely focused ion beam technique

According to a further embodiment of the invention, the source of ions is indium, gallium, platinum, gold, silver or copper.

According to a further embodiment of the invention, the surface defects are created by nanoindenting with a diamond-pointed probe used in scanning probe microscopy.

### SHORT DESCRIPTION OF THE DRAWINGS

The invention will be described more in detail below in application examples and with reference to the accompanying drawings in which

FIGS. 1A and B show arrays of surface defects created by a finely focused ion beam before and after exposure to a solution of human serum albumin, and

FIGS. 2A and B show arrays of surface defects created by nanoindenting.

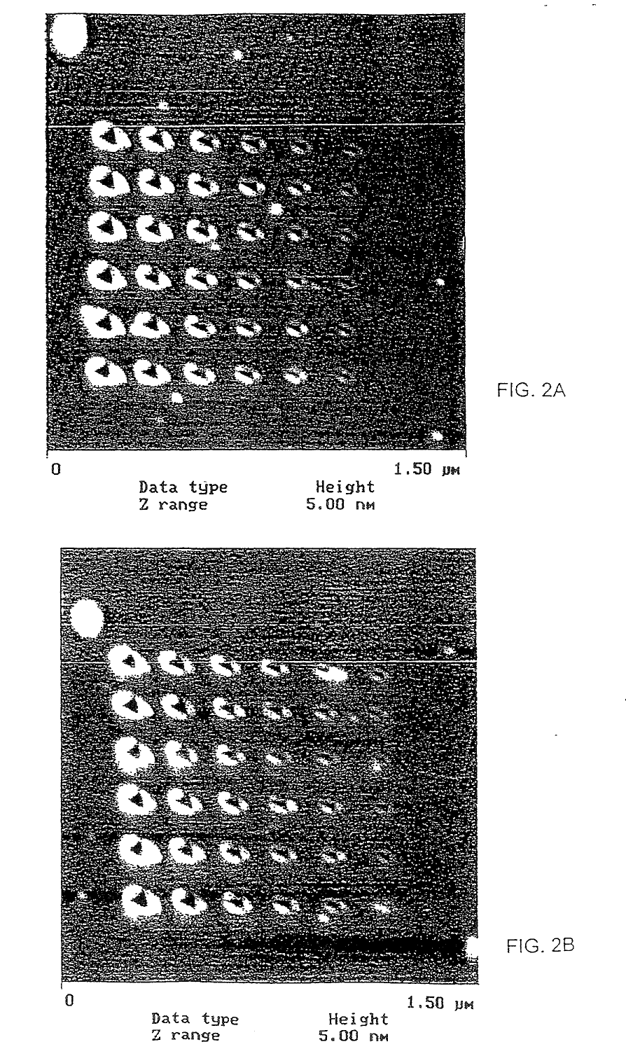

### DETAILED DESCRIPTION OF THE INVENTION

The invention will now be illustrated in detail with the aid of the following application examples.

### Preparation of Holes in Rows Intended for Selective Immobilisation of Particles or Macromolecules to These Holes

A variation of the diameter of the holes makes it possible to vary the number of molecules or paticles being adhered to these. In the most extreme case the holes or rises are made with molecular dimensions, which means that single molecules or particles can be adhered to the underlayer.

When using finely focused ion beam technique, the ion source can be variated so that a material which is most suitable for the intended application can be deposited on the defect made in the surface, to which material a stronger immobilisation of a macromolecule or particle can be made. Protein molecules are strongly adsorbed to platinum and palladium, and in this case the ion source for the finely focused ion beam should be platinum or palladium.

Another method would be sputtering of gold onto the surface defects, to which tiolated proteins or particles are immobilized.

### Forming of a Row of Nanoparticles for Developing Electric Circuits for Information Transfer

Defects are created in the surface with the aid of finely focused ion beam technique or nanoindenting technique. E.g. lines with a suitable depth and diameter are made in the surface. Nanoparticle of organic or inorganic origin are added to the surface and they will collect in the created defects. Excess nanoparticles are removed mechanically with pressurized air, shaking, centrifugation or any other suitable method for removal. Thereafter the surface provided with particles is heated to melting point in order to obtain a continuous thread of the material, intended for different uses such as information transfer.

### Particles or Macromolecules of Biomaterial in Different Positions

By making holes in a first step, e.g. with finely focused ion beam technique, where the distance between the holes can be varied as well as their mutual positions, in a next step nanoparticles or macromolecules fitting in the holes can be added. The nanoparticles may e.g. consist of the well known bioactive substance hydroxyapatit or other types of bioactive materials to which the cellular surface adheres. An example of suitable macromolecules are the so called integrin family, i.e. vitronektin and fibronektin, which are so called cellular “glues” for adhering of cells to different surfaces. Concerning biomaterial applications it is important to consider the adherence of the cell and its spreading on the surface, see E. Rouslahti, Science, vol. 276, pp. 1345-1347, 1997, in order to obtain good biocompatible characteristics.

### Biomolecular Memories

Since the surface can be modulated in x-, y-, and z-directions there arises the possibility to create a surface above this topographical chart, which surface varies in x-, y- and z-directions physically-chemically by adding e.g. peptides or amino acids to positions on the surface having been ion beam treated or nanoindented. This leads to the creation of artificial membranes or biological memory surfaces which are recognized by other macromolecules. In connection with the binding-in of molecules, voltage differentials can arise, which can be used as signal generators. Other possibilities are the use of the artificially created memory surface for separation or analysis. Alternatively, the memory surface can be used for the development of drugs, where a certain membrane structure corresponds with a pharmaceutically active molecule structure.

### Analytical Measuring Methods and Separation Methods for Analysis and Separation of Single Molecules and Particles

As was mentioned above the surface can be coated with polymers of inorganic or organic material. With the ion beam can then selective surface modifications be done, which result in that the ion beam treated area will have other chemical or mechanical characteristics. To these areas a selective particle or molecule binding-in can be obtained. Since the applied surface coating can be made with varying thickness there is also the possibility of making holes with different depths but also different diameters, e.g. for molecular filter applications.

For analytical purposes a selective adsoprtion to certain positions only has several important advantages. A quicker reading of the surface is one of these advantages, for example after an immunodiagnostic reaction has taken place. The reading will be safer because of the fact that the changes in exactly these points can be observed in detail. After repeated scans of the surface an improved evaluation can be obtained by use of Fourier-Transformation analyses.

### Biocatalytical Surfaces

Biocatalytical systems most often exists bound to surfaces. The catalyse is achieved among other things because of reduced diffusion distances and because high local concentrations can arise. Other examples of important factors for increased biocatalyse exist in photosynthetic systems where voltage differences are used for electron cascades.

A positioning of molecules means that these characteristics can be used to a full extent, which can be performed with finely focused ion beam technique, but also with nanoindenting.

### Example

Site-Selective adsorption of human serum albumin molecules on well ordered defect arrays.

### Materials and Methods

A well ordered array of defects was prepared on a silicon surface, using a finely focused ion beam with 30 keV indium ions in a 11 pA beam current. The beam spot size was 15 nm, and approximately a 10 second milling time was used for each 5 μm×5 μm area.

The total array consisted of 16 milling areas, each with an array of holes with an estimated diameter of 50 nm. The spacing between individual defects was about 160 nm.

The defect array was imaged with a scanning force microscope run in tapping mode (TM-SFM) under ambient conditions. The scanning force microscope employed was a Nanoscope III® (Digital Instruments Inc., Santa Barbara, Calif., USA). The TM-SFM tips have a radius of ≈10 nm, as specified by the manufacturer.

Human serum albumin (HSA) (Sigma Chemical Co., St Louis, Mo., USA) was dissolved in 15 nM HEPES buffer, (N-[2-Hydroxyethyl]piperazine-N′-[2-ethanesulfonic acid]), pH 7.5, at a concentration of 0.6 μg/ml. 30 μl of the HSA solution was placed on the silicon so that it covered the array, and was then rinsed off with 1 ml of HEPES buffer after 2 minutes. The surface was then dried using a flow of nitrogen, and probed again with TM-SFM.

The same array area that was scanned before the adsorption of HSA, could easily be found again after the adsorption, due to recognition of the array pattern. The tip was placed roughly in roughly the correct position with the help of an optical microscope, and in a 20×20 μm scan, the area could be recognised from previous scans. Thus the same individual holes could be imaged before and after the adsorption of proteins.

### Results

The images of the array show that the holes have a diameter of=50 nm and the spacing between the holes is=160 nm. The holes have only very slightly elevated rims (FIG., 1A). The depth of the holes may not de detected with the AFM, due to the bulkiness of the tip compared to the size of the hole.

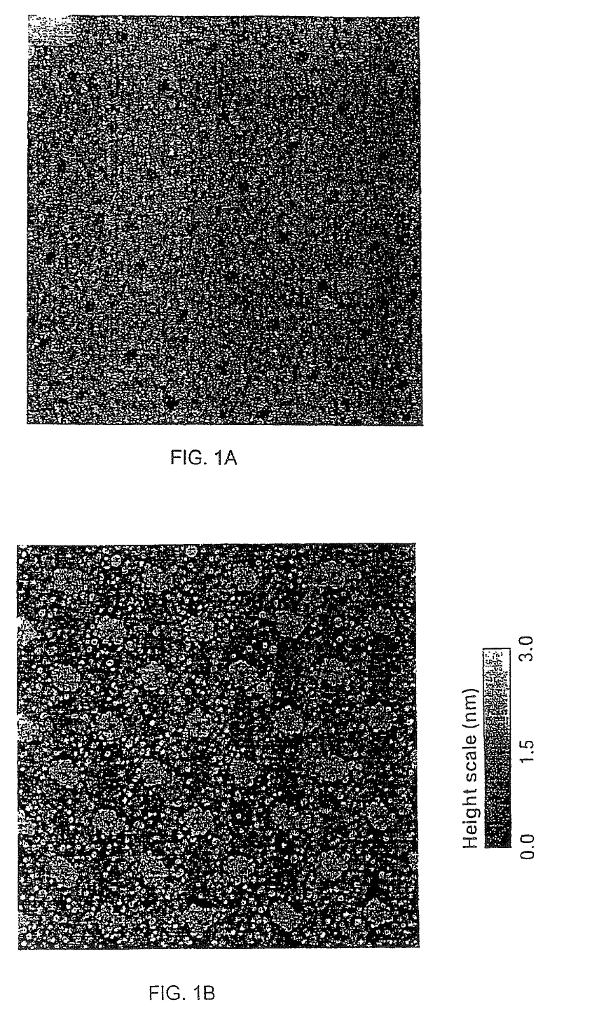

After adsorption of HSA, the rims of the holes were decorated with several molecules of HSA (FIG. 1B). There were very few or none of the HSA molecules adsorbed on the areas between the defects ordered in arrays. There was clearly a selective adsorption of HSA molecules to the well ordered array of defects.

The image size in FIGS. 1A and 1B, respectively is 1 μm×1 μm.

1. A method of arraying nanoparticles and macromolecules on surfaces, wherein a pattern of surface defects is created on a surface, said surface defects having a diameter, and a depth and a height, respectively, within the interval of 1-50 nanometers, and a mutual distance within the interval of 0.1-1000 nanometers, the form, appearance and mapping out of said surface defects being adapted to said nanoparticles and/or macromolecules which are to be arrayed.

2. Method according to claim 1, wherein surface defects in the form of lines are created in the surface.

3. Method according to any one of claims 1-2, wherein the surface is comprised of organic or inorganic material.

4. Method according to any one of claims 1-3, wherein the surface is coated with polymers of inorganic or organic material before the formation of surface defects, and wherein subsequently selective surface modifications are made in order to provide the area containing the surface defects with special chemical or mechanical characteristics.

5. Method according to claim 4, wherein the thickness of the coating is varied throughout the surface whereby holes with different depths and/or diameters can be created.

6. Method according to any one of the preceding claims, wherein the surface defects are created by using finely focused ion beam technique.

7. Method according to claim 6, wherein the source of ions is selected among indium, gallium, platinum, gold, silver or copper.

8. Method according to any one of claims 1-5, wherein the surface defects are creating by nanoindenting with the diamond-pointed probe used in scanning probe microscopy.

9. Method according to claim 1, wherein nanoparticles or macromolecules are arrayed in the surface defects with known positions on the surface, whereupon the surface is scanned several times, and the readings evaluated by use of Fourier-Transformation analysis.
